(19) United States
(12) Patent Application Publication
(10) Pub. No.: US 2013/0103456 A1
(43) Pub. Date: Apr. 25, 2013

(54) METHOD, SYSTEM AND PROGRAM STORAGE DEVICE FOR PRODUCTION PLANNING

(71) Applicants: ALLISON R. BANNISTER, Burlington, NY (US); Robert A. Orzell, Essex Junction, VT (US); James J. Schick, Colchester, VT (US); Jacqueline N. Ward, South Hero, VT (US)

(72) Inventors: ALLISON R. BANNISTER, Burlington, NY (US); Robert A. Orzell, Essex Junction, VT (US); James J. Schick, Colchester, VT (US); Jacqueline N. Ward, South Hero, VT (US)

(73) Assignee: International Business Machines Corporation, Armonk, NY (US)

(21) Appl. No.: 13/280,489

(22) Filed: Oct. 25, 2011

(51) Int. Cl. G06Q 10/06

(52) U.S. Cl. 705/7.31; 705/7.29

(57) ABSTRACT

Disclosed are embodiments of a production planning method, system and program storage device. The embodiments calculate and compare, in sequence, a first running cumulative sum of the average item quantity per a regular time interval for all demands within a specified time period and a second running cumulative sum of specific item quantities per the same regular interval for only high priority demands within the same time period. When a given entry in the first running cumulative sum is less than a corresponding entry in the second running cumulative sum, demand leveling is performed. Comparing and demand leveling are iteratively repeated until no entries in the first running cumulative sum, as updated, are less than corresponding entries in the second running cumulative sum. The results can then be used for production planning in order to achieve near-capacity manufacturing and meet at least the high priority customer demands.

### BACKGROUND

1. Field of the Invention

The embodiments disclosed herein relate to production planning and, more particularly, to a method, system and program storage device for production planning in manufacturing.

2. Description of the Related Art

Generally, in production planning in manufacturing, a customer demand refers to a demand (e.g., an actual order or forecasted order) to produce an item and, specifically, to produce a specified number (i.e., quantity) of that item by a given date. The item can refer, for example, to an end product, an assembly, a sub-assembly, a component, etc. A fundamental problem in production planning is that, at any given time, customer demands for the item may be either greater than the current manufacturing production capacity (i.e., greater than the expected output, by the manufacturer, of that item in a given period of time) or less than the current manufacturing production capacity. If the customer demands in a given period of time are greater than the manufacturing production capacity, at least some of those demands will not be met. However, if the customer demands in a given period of time are less than the manufacturing production capacity, manufacturing resources (i.e., anything required for production, such as production facilities or plants, production lines, supplies, etc.) will be under-utilized. Therefore, there is a need in the art for a production planning technique that, for a given time horizon, levels out customer demands in a manner that both achieves near-capacity manufacturing and, thereby avoids under-utilization of manufacturing resources and also ensures that at least some customer demands and, particularly, all high priority customer demands, are met.

### SUMMARY

In view of the foregoing, disclosed herein are embodiments of a production planning method, system and program storage device. The embodiments can calculate and compare, in sequence, a first running cumulative sum of the average item quantity per a regular time interval (e.g., per day) for all demands within a specified time period and a second running cumulative sum of specific item quantities per the same regular interval (e.g., per day) for only high priority demands within the same specified time period. When a given entry in the first running cumulative sum is less than a corresponding entry in the second running cumulative sum, demand leveling can be performed. That is, a leveling item quantity can be added to the average item quantities associated with at least some entries up to and including the given entry. Then, the first running cumulative sum can be re-calculated to generate an updated first running cumulative sum. The comparing and demand leveling processes can be iteratively repeated until none of the entries in the first running cumulative sum, as updated, are less than the corresponding entries in the second running cumulative sum (i.e., until demand leveling is achieved). The results of such demand leveling can then be used for production planning in order to achieve near-capacity manufacturing and meet at least the high priority customer demands.

More particularly, disclosed herein are embodiments of a computer-implemented production planning method in manufacturing. The method embodiments can comprise storing, in memory, multiple demands. These multiple demands can comprise high priority demands and low priority demands.

The method embodiments can further comprise determining the total item quantity associated with all demands within a specified time period. Then, based on the total item quantity and for each regular time interval (e.g., each day) within the specified time period, an average item quantity can be determined (e.g., a daily average item quantity). Next, for all demands within the specified time period, a first running cumulative sum of the average item quantities can be calculated from a first regular time interval (e.g., a first day) to a last regular time interval (e.g., a last day) in sequence. Additionally, for only high priority demands within the specified time period, a second running cumulative sum of specific item quantities can be calculated from the first regular time interval (e.g., the first day) to the last regular time interval (e.g., the last day) in sequence.

Entries in the first running cumulative sum can then be compared, in sequence beginning with the first regular time interval (e.g., beginning with the first day), to corresponding entries in the second running cumulative sum. Specifically, the entries in the running cumulative sums can be compared in sequence to determine if a given entry in the first running cumulative sum associated with all of the demands within the specified time period is less than a corresponding entry in the second running cumulative sum associated with only the high priority demands within the specified time period.

When a given entry in the first running cumulative sum is less than a corresponding entry in the second running cumulative sum, demand leveling can be performed. Specifically, a demand-leveling item quantity can be added to the average item quantity associated with at least some entries up to and including the given entry. Then, the first running cumulative sum can be re-calculated in order to generate an updated first running cumulative sum. The comparing and demand leveling processes can be iteratively repeated until none of the entries in the first running cumulative sum, as updated, are less than the corresponding entries in the running cumulative sum associated with only high priority demands (i.e., until demand leveling is achieved). The results of such demand leveling can then be used for production planning in order to achieve near-capacity manufacturing and meet at least the high priority customer demands.

Also disclosed herein are embodiments of a computer system for production planning in manufacturing. This system can comprise a memory and one or more processors in communication with the memory.

The memory can store multiple demands. The multiple demands can comprise high priority demands and low priority demands.

The processor(s) can determine the total item quantity associated with all demands within a specified time period. Next, based on the total item quantity and for each regular time interval (e.g., each day) within the specified time period, the processor(s) can determine an average item quantity (e.g., daily average item quantity). Then, the processor(s) can calculate two different running cumulative sums: (1) for all demands within the specified time period, a first running cumulative sum of the average item quantities from a first regular time interval (e.g., a first day) to a last regular time interval (e.g., a last day) in sequence; and (2) for the high priority demands only, a second running cumulative sum of the specific item quantities from the first regular time interval (e.g., the first day) to the last regular time interval (e.g., the last day) in sequence.

The processor(s) can further compare, in sequence beginning with the first regular time interval (e.g., beginning with the first day), entries in the first running cumulative sum to corresponding entries in the second running cumulative sum. Specifically, the processor(s) can compare, in sequence, the entries in the running cumulative sums to determine if a given entry in the first running cumulative sum associated with all of the demands within the specified time period is less than a corresponding entry in the second running cumulative sum associated with only the high priority demands within the specified time period.

When a given entry in the first running cumulative sum is less than a corresponding entry in the second running cumulative sum, the processor(s) can further perform demand leveling. Specifically, the processor(s) can add a demand-leveling item quantity to the average item quantity associated with at least some entries up to and including the given entry. Then, the first running cumulative sum can be re-calculated in order to generate an updated first running cumulative sum. The comparing and demand leveling processes can be iteratively repeated by the processor(s) until none of the entries in the first running cumulative sum, as updated, are less than the corresponding entries in the running cumulative sum associated with only high priority demands (i.e., until demand leveling is achieved). The results of such demand leveling can then be output by the computer system and used for production planning in order to achieve near-capacity manufacturing and meet at least the high priority customer demands.

Also disclosed herein are embodiments of a non-transitory program storage device. The program storage device can be readable by a computer and can tangibly embody a program of instructions executable by the computer to perform the production planning method, as described in detail above.

### BRIEF DESCRIPTION OF THE SEVERAL VIEWS OF THE DRAWINGS

The embodiments herein will be better understood from the following detailed description with reference to the drawings, which are not necessarily drawing to scale and in which:

FIG. 1A is a graph illustrating customer demands compared to manufacturing production capacity.

FIG. 1B is a graph illustrating adjusted customer demands compared to manufacturing capacity as generated using the method, system and/or program storage device embodiments disclosed herein.

FIG. 2 is a flow diagram illustrating embodiments of a production planning method;

FIG. 3 is another flow diagram illustrating process step 216 of FIG. 2;

FIG. 4 is a schematic diagram illustrating embodiments of a production planning system;

FIG. 5 is an exemplary table illustrating the output of the disclosed embodiments; and

FIG. 6 is a schematic diagram illustrating an exemplary hardware environment for implementing the disclosed embodiments.

### DETAILED DESCRIPTION

The detailed description of the embodiments below is provided for purposes of illustration and is not intended to be exhaustive. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, and/or to enable others of ordinary skill in the art to understand the embodiments disclosed herein.

As mentioned above, generally, in production planning in manufacturing, a customer demand refers to a demand (e.g., an actual order or forecasted order) to produce an item and, specifically, to produce a specified number (i.e., quantity) of that item by a given date. The item can refer, for example, to an end product, an assembly, a sub-assembly, a component, etc.

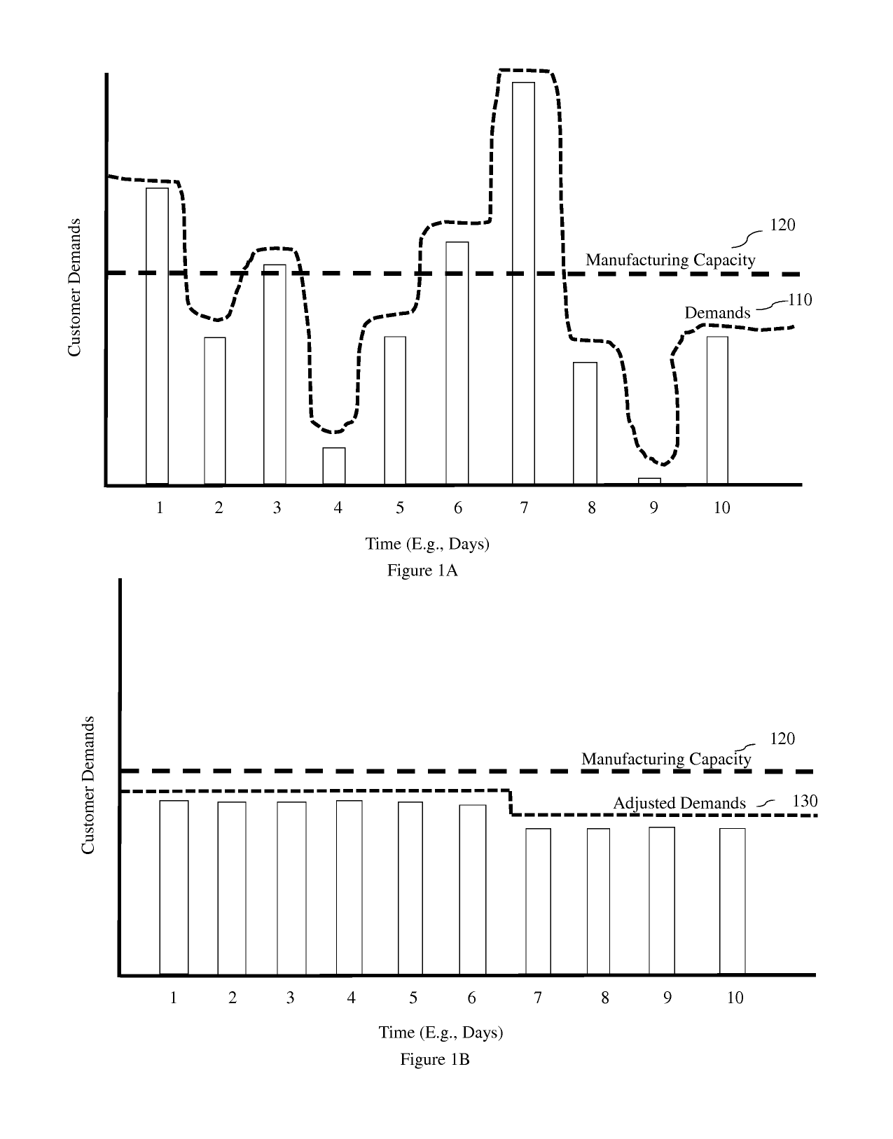

FIG. 1A is a graph that illustrates customer demands 110 at regular time intervals over a specified period of time (e.g., daily item quantities associated with customer demands) as compared to manufacturing production capacity 120 at the same regular time intervals over the same period of time (e.g., daily item quantities that can be produced by a manufacturer). As shown in the graph, a fundamental problem in production planning is that, at any given time, the customer demands 110 for an item may be either greater than the current manufacturing production capacity 120 (e.g., days 1, 3, 6 and 7) or less than the current manufacturing production capacity 120 (e.g., days 2, 4, 5 and 8-10). If the customer demands in a given period of time are greater than the manufacturing production capacity, at least some of those demands will not be met. However, if the customer demands in a given period of time are less than the manufacturing production capacity, manufacturing resources (i.e., anything required for production, such as production facilities or plants, production lines, supplies, etc.) will be under-utilized. Therefore, there is a need in the art for a production planning technique that, for a given time horizon, levels out the demands (e.g., see adjusted demands 130 of FIG. 1B) across the specified time period in a manner that both achieves near-capacity manufacturing and, thereby avoids under-utilization of manufacturing resources and also ensures that at least high priority customer demands are met.

In view of the foregoing, disclosed herein are embodiments of a production planning method, system and program storage device. The embodiments can calculate and compare, in sequence, a first running cumulative sum of the average item quantity per a regular time interval (e.g., per day) for all demands within a specified time period and a second running cumulative sum of specific item quantities per the same regular interval (e.g., per day) for only high priority demands within the same specified time period. When a given entry in the first running cumulative sum is less than a corresponding entry in the second running cumulative sum, demand leveling can be performed. That is, a leveling item quantity can be added to the average item quantities associated with at least some entries up to and including the given entry. Then, the first running cumulative sum can be re-calculated to generate an updated first running cumulative sum. The comparing and demand leveling processes can be iteratively repeated until none of the entries in the first running cumulative sum, as updated, are less than the corresponding entries in the second running cumulative sum (i.e., until demand leveling is achieved). The results of such demand leveling can then be used for production planning in order to achieve near-capacity manufacturing and meet at least the high priority customer demands.

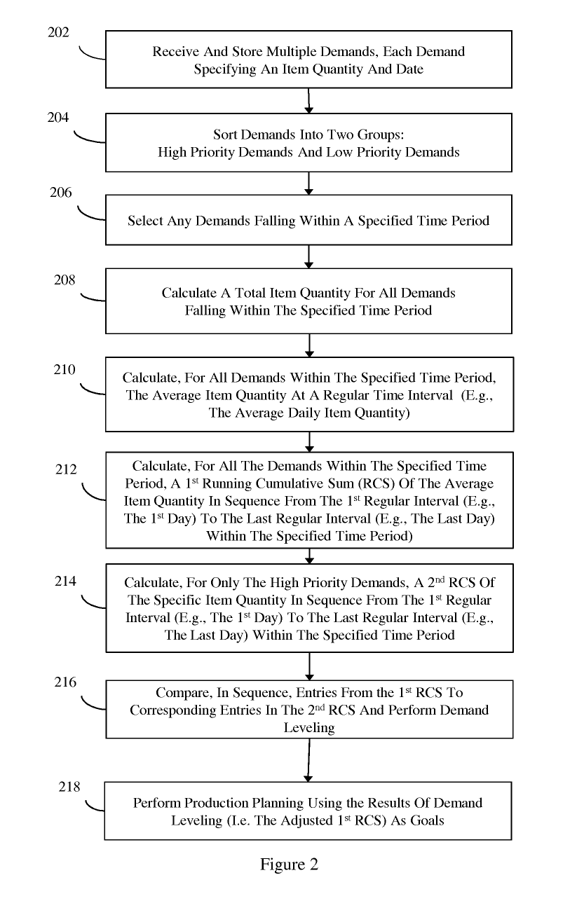

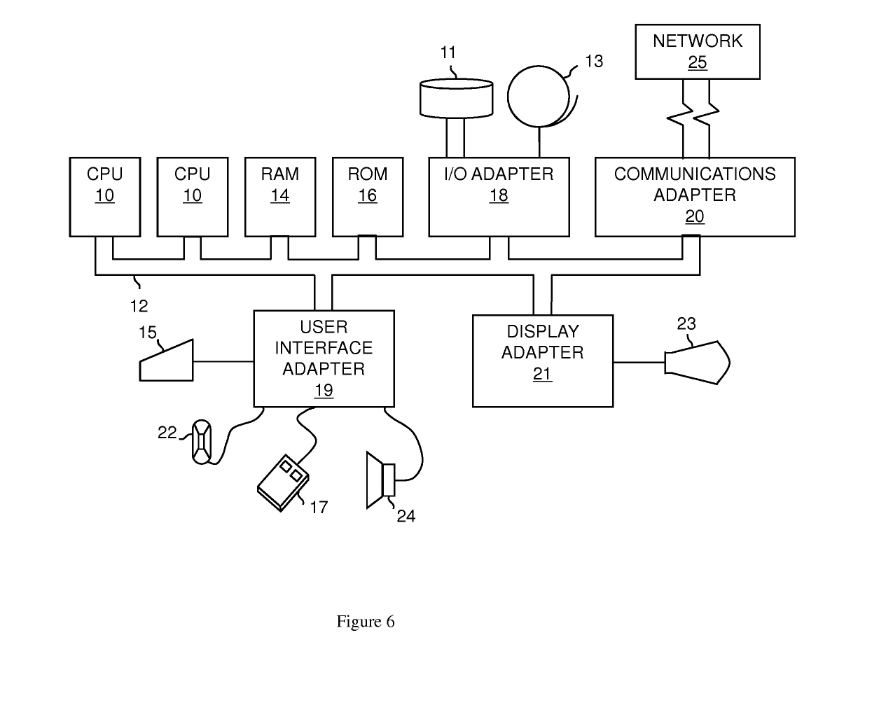

More particularly, referring to the flow diagram of FIG. 2, disclosed herein are embodiments of a production planning method in manufacturing. The method embodiments can be implemented, for example, in a computer hardware environment (e.g., a computer system) such as that described in detail below and depicted in FIG. 6. Alternatively, the method embodiments could be implemented on any other type of computer system having the required data storage and processing capability to perform the described production planning processes (e.g., a laptop computer, tablet computer, handheld device, smart phone, etc.).

Specifically, the method embodiments can comprise receiving, by the computer system, and storing, in memory, multiple demands (e.g., customer orders, either actual or forecasted) for an item (202). This item can, for example, comprise an end product, an assembly, a sub-assembly, a component, etc. Each demand can specify an item quantity (i.e., a specified quantity of the item) and a date (e.g., a delivery date, a due date, etc.).

The demands can further be sorted, by the computer system, into two groups: high priority demands and low priority demands (204). The process 204 of sorting the demands into high and low priority demands can be performed according to predefined sorting rules (e.g., as stored in memory). Such sorting rules can specify, for example, that any demands associated with actual customer orders are to be considered high priority demands and any demands associated with forecasted customer orders are to be considered low priority demands. Alternatively, the sorting rules can specify that any demands associated with large item quantities (e.g., >100, >1000, >10,000, etc.) are to be considered high priority demands and any demands associated with low item quantities (e.g., <100, <1000, <10,000, etc.) are to be considered low priority demands. Alternatively, the sorting rules can specify that any demands associated with specific customers by name are to be considered high priority demands and all other demands are to be considered low priority demands. It should be understood that the exemplary sorting rules discussed above are offered for illustration purposes and, alternatively, any other predefined rules that can be used to sort demands into groups with different priorities for purposes of production planning could be used.

It should be noted that this sorting process could be performed in conjunction with or immediately following (as shown) the storage of the demands in memory at process 202. Alternatively, this sorting process can be performed at some later time prior to the calculation or a running cumulative sum at process step 214, discussed in detail below (e.g., in conjunction with or immediately following the selection of any demands falling within the specified time period at process 206, as discussed in detail below).

Once the demands are stored in memory, the memory can be accessed in order to select (i.e., identify), for production planning purposes, any demands that fall within a specified time period in the future (i.e., a specified time horizon) (206). That is, the stored demands can be reviewed to identify any demand having a date that falls within the specified time period. The specified time period can comprise, for example, a specified number of days, a week, a month, a quarter year, a half year, a year, etc. and can begin as of the current date or some further date.

The method embodiments can further comprise performing, by the computer system, a number of calculations with respect to all the demands falling within the specified time period and also with respect to only high priority demands falling within the specified time period (208-216).

Specifically, the total item quantity associated with all demands that fall within the specified time period can be calculated (208). That is, the demands that fall within the specified time period can be reviewed, and the total sum of items to be manufactured according to those demands can be determined. Then, a regular time interval within the specified time period (e.g., a work shift, a day, a specified number of days, a week, a month, etc.) can be selected and, for all demands within the specified time period, the average item quantity at that regular time interval can be calculated (210). For example, if the selected regular time interval is a day, a daily average item quantity within the specified time period can be calculated; if the selected regular time interval is a single work shift, the average item quantity for each work shift within the specified time period can be calculated; and so on.

Next, for all of the demands within the specified time period, a first running cumulative sum of average item quantities can be calculated from a first regular time interval (e.g., a first day) to a last regular time interval (e.g., a last day) in sequence (212). Specifically, in calculating the first running cumulative sum: a first entry for the first regular time interval (e.g., the first day) will be equal to the average item quantity determined at process 210; a second entry for the second regular time interval (e.g., the second day) will be equal to the value from the first entry plus the average item quantity determined at process 210; a third entry for the third regular time interval (e.g., the third day) will be equal to the value of the second entry plus the average item quantity determined at process 210; and so on.

Additionally, for only the high priority demands within the specified time period, a second running cumulative sum of specific item quantities can be calculated from the first regular time interval (e.g., the first day) to the last regular time interval (e.g., the last day) in sequence (214). Specifically, in calculating the second running cumulative sum: a first entry for the first regular time interval (e.g., the first day) will be equal to the specific item quantity associated with the high priority demands only and due in the first regular time interval (e.g., due on the first day); a second entry for the second regular time interval (e.g., the second day) will be equal to the value from the first entry plus the specific item quantity associated with the high priority demands only and due in the second regular time interval (e.g., due on the second day); a third entry for the third regular time interval (e.g., a third day) will be equal to the value from the second entry plus the specific item quantity associated with the high priority demands only and due in the third regular time interval (e.g., on the third day); and so on.

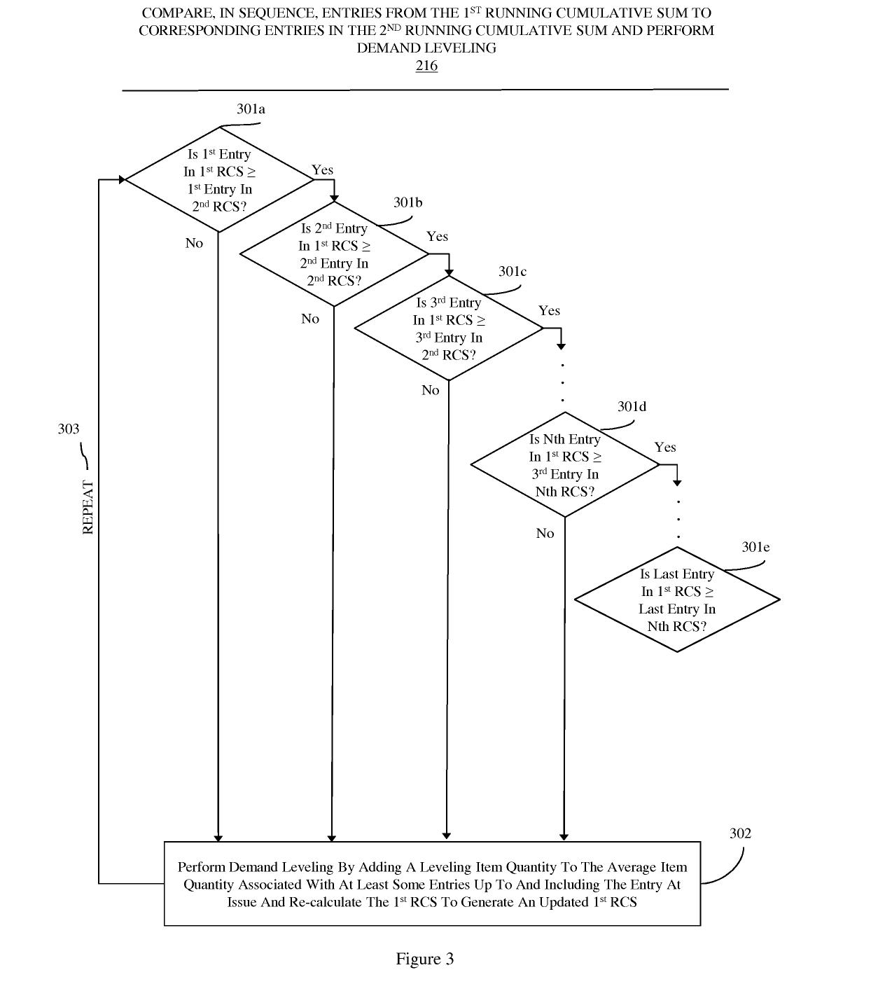

Entries in the first running cumulative sum can then be compared, by the computer system and in sequence beginning with the first regular time interval (e.g., beginning with the first day), to corresponding entries in the second running cumulative sum and demand leveling can be performed (216). Specifically, referring to FIG. 3, the entries in the running cumulative sums can be compared in sequence to determine if a given entry in the first running cumulative sum is less than a corresponding entry in the second running cumulative sum (see items 301a-301e). That is, a determination is made as to whether or not the first entry in the first running cumulative sum is greater than or equal to the corresponding first entry in the second running cumulative sum (301a); if so, a determination is made as to whether or not the second entry in the first running cumulative sum is greater than or equal to the corresponding second entry in the second running cumulative sum (301b); if so, a determination is made as to whether or not the third entry in the first running cumulative sum is greater than or equal to the corresponding third entry in the second running cumulative sum (301c); and so on.

If or when it is determined (e.g., at 301a, 301b, 301c, . . . or at 301e) that a given entry in the first running cumulative sum is less than a corresponding entry in the second running cumulative sum, demand leveling can be performed (e.g., automatically and immediately) by the computer system (302). That is, a leveling item quantity can be added to the average item quantities associated with at least some of the entries up to and including the given entry.

Specifically, when a given entry in the first running cumulative sum is less than a corresponding entry in the second running cumulative sum, the difference between the given entry and the corresponding entry can be divided by the entry number within the first running cumulative sum wherein the difference is found (e.g., the day number, such as day 20). Then result (i.e., the quotient) can be added to the average item quantity associated with at least some entries up to and including the given entry (e.g., to the daily average item quantity associated with at least some entries between the first day and the day on which the given entry is found). This process can be performed according to pre-defined demand-leveling rules.

For example, a demand-leveling rule can indicate that, if the difference between the given entry in the first running cumulative sum and its corresponding entry in the second running cumulative sum divided by the number of the given entry is less than one time, one item can be added to each of the average item quantities in sequence starting with the average item quantity associated with the first entry until the entire difference is accounted for. For example, a difference of 15 divided by an entry number of 20 is less than one, so one item can be added to the average item quantity associated with each of the first fifteen entries. Alternatively, in this case, the demand-leveling rule can indicate that one item can be added to the average item quantity associated with 15 different uniformly distributed entries from the entry 1 to entry 20 (e.g., to entries 1-3, 5-7, 9-11, 13-15 and 17-29). Alternatively, in this case, the demand-leveling rule can indicate that the result (i.e., the quotient) be rounded up to one and one item can be added to the average item quantity associated each of the entries 1-20.

Another demand-leveling rule can indicate that, if the difference between the given entry in the first running cumulative sum and its corresponding entry in the second running cumulative sum divided by the number of the given entry is equal to a whole number (i.e., if the difference can be divided equally be the entry number), that whole number of items can be added to the average item quantities associated with all entries up to and including the given entry. For example, a difference of 100 divided by an entry number of 20 is exactly 5, so 5 can be added to the average item quantity associated with entries 1-20.

Finally, yet another demand-leveling rule can indicate that, if the difference between the given entry in the first running cumulative sum and its corresponding entry in the second running cumulative sum cannot be divided equally by the entry number and if the result is greater than one (i.e., if the result is a whole number plus a remainder), that whole number of items can be added to the average item quantities associated with the first entry through the given entry, plus one additional item can be added to the entries in sequence starting with the average item quantity associated with the first entry until the entire remainder is accounted for. For example, a difference of 83 divided by an entry number of 20 is 4 with a remainder of 3, so 4 can be added to the average item quantities associated with entries 1-20 and one additional item can be added to the entries 1-3. Alternatively, in this case, the demand-leveling rule can indicate that, instead of adding one additional item to entries 1-3, the one additional item can be distributed approximately uniformly to the average item quantities associated with 3 different uniformly distributed entries from the first entry to twentieth entry (e.g., to entries 1, 10, and 19). Alternatively, in this case, the demand-leveling rule can indicate that the result (i.e., the quotient) can be rounded up to the next whole number (e.g., 5) and that next whole number of items can be added to the average item quantities associated with all of the entries 1-20.

Once the leveling item quantity is added, as discussed above, the first running cumulative sum can be re-calculated in order to generate and updated first running cumulative sum (302).

Then, the comparing and demand leveling processes can be iteratively repeated (303) until none of the entries in the first running cumulative sum, as updated, are less than the corresponding entries in the second running cumulative sum associated with only high priority demands (i.e., until demand leveling is achieved). That is, referring again to FIG. 3, after demand leveling at process 302, processes 301a, 301b, etc. are repeated until another entry in the first running cumulative sum is determined to be less than a corresponding second entry in the second running cumulative sum, at which time process 302 is repeated, or until it is determined at process 301e that none of the entries in the first running cumulative sum, as updated, are less than the corresponding entries in the second running cumulative sum.

It should be noted that, as a result of demand leveling, demands are shifted towards the beginning of the specified time period and, thus, the total item quantity associated with all demands will likely be met prior to the end of the specified time period.

The results of such demand leveling (i.e., the final output and, particularly, the finally updated first running cumulative sum following process step 301e) can then be used as the goal for production planning in order to achieve near-capacity manufacturing and meet at least the high priority customer demands (218).

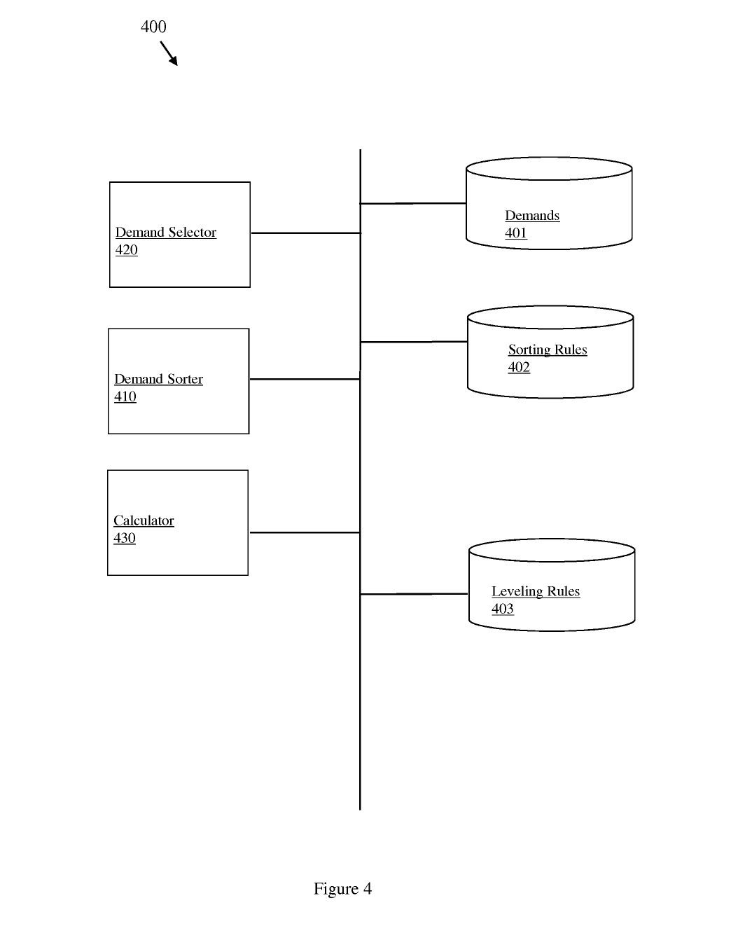

Referring to FIG. 4, also disclosed herein are embodiments of a computer system 400 for production planning in manufacturing. The system embodiments can be implemented, for example, in a computer hardware environment such as that described in detail below and depicted in FIG. 6. This system 400 can comprise one or more memory devices that store demands, pre-defined rules, etc. and one or more processors in communication with the memory device(s) and comprising at least a demand sorter 410, a demand selector 420, and a calculator 430.

Specifically, the system 400 can comprise memory device(s) that store (i.e., are adapted to store, are configured to store, etc.) multiple demands 401 (e.g., customer orders, either actual or forecasted) for an item. This item can, for example, comprise an end product, an assembly, a sub-assembly, a component, etc. Each demand can specify an item quantity (i.e., a specified quantity of the item) and a date (e.g., a delivery date, a due date, etc.). The memory device(s) can further store (i.e., can be adapted to store, configured to store, etc.) pre-defined demand sorting rules 402, pre-defined demand-leveling rules 403, etc., as discussed in detail below.

The demand sorter 410 can sort (i.e., can be adapted to sort, programmed to sort, configured to sort, etc.) demands into two groups: high priority demands and low priority demands. The demand sorter 410 can specifically sort the demands into high and low priority demands according to predefined sorting rules 402 stored in memory (e.g., in the same manner as discussed in detail above with regard to process step 204 of FIG. 2). Sorting by the demand sorter 410 can, for example, be performed in conjunction with or immediately following the storage of the demands in memory. Alternatively, sorting by the demand sorter 410 may be performed at any time before calculations related to high priority demands are to be performed by the calculator 430 (see detailed discussion below).

The demand selector 420 can access and review the demands and, based on the review, can select (i.e., can be adapted to select, can be configured to select, can be programmed to select, etc.) any demands that fall within a specified time period in the future (i.e., a specified time horizon) for production planning purposes (e.g., in the same manner as discussed in detail above with regard to process step 206 of FIG. 2). The specified time period can comprise, for example, a specified number of days, a week, a month, a quarter year, a half year, a year, etc. and can begin as of the current date or some further date.

The calculator 430 can be in communication with the demand selector 420 and can perform (i.e., can be adapted to perform, can be configured to perform, can be programmed to perform, etc.) a number of calculations with respect to all those demands falling within the specified time period and also with respect to only high priority demands falling within the specified period of time. Specifically, the calculator 430 can calculate the total item quantity associated with all demands that fall within the specified time period can be calculated. That is, demands that fall within the specified time period can be reviewed, and the total sum of items to be manufactured can be determined (e.g., in the same manner as discussed in detail above with regard to process step 208 of FIG. 2).

Based on the total item quantity, the calculator 430 can further calculate the average item quantity at a regular time interval within the specified time period (e.g., in the same manner as discussed in detail above with regard to process step 210 of FIG. 2). The regular time interval can be predetermined and can comprise, for example, a work shift, a day, a specified number of days, a week, a month, etc.

Next, the calculator 430 can calculate, for all of the demands within the specified time period, a first running cumulative sum of average item quantities from a first regular time interval (e.g., a first day) to a last regular time interval (e.g., a last day) in sequence (e.g., in the same manner as discussed in detail above with regard to process step 212 of FIG. 2).

Additionally, the calculator 430 can calculate, for only the high priority demands within the specified time period, a second running cumulative sum of specific item quantities from the first regular time interval (e.g., the first day) to the last regular time interval (e.g., the last day) in sequence (e.g., in the same manner as discussed in detail above with regard to process step 214 of FIG. 2).

Next, the calculator 430 can compare entries in the first running cumulative sum, in sequence beginning with the first regular time interval (e.g., beginning with the first day), to corresponding entries in the second running cumulative sum and, based on the comparison, perform demand leveling (e.g., in the same manner as discussed in detail above with regard to process step 216 of FIG. 2 and FIG. 3).

Specifically, the calculator 430 can compare the entries in the running cumulative sums in sequence to determine if a given entry in the first running cumulative sum associated with all of the demands within the specified time period is less than a corresponding entry in the second running cumulative sum associated with only the high priority demands within the specified time period. If or when the calculator 430 determines that a given entry in the first running cumulative sum is less than a corresponding entry in the second running cumulative sum, the calculator 430 can immediately and automatically perform demand leveling. That is, when a given entry in the first running cumulative sum is less than a corresponding entry in the second running cumulative sum, the calculator 430 can add a leveling item quantity to the average item quantities associated with at least some of the entries up to and including the given entry, as discussed in detail above with regard to process step 302 of FIG. 3. Once the leveling item quantity is added, the calculator 430 can re-calculate the first running cumulative sum in order to generate and updated first running cumulative sum.

The calculator 430 can iteratively repeat the comparing and demand leveling processes until none of the entries in the first running cumulative sum, as updated, are less than the corresponding entries in the second running cumulative sum associated with only high priority demands (i.e., until demand leveling is achieved).

The computer system 400 can further comprise an output (e.g., a printer, a display, etc.) that outputs the results of such demand leveling (i.e., the final output and, particularly, the finally updated first running cumulative sum from the calculator 430) to be used as a goal for production planning in order to achieve near-capacity manufacturing and meet at least the high priority customer demands.

It should be noted that, as a result of demand leveling by the calculator 430, demands are shifted towards the beginning of the specified time period and, thus, the total item quantity associated with all demands will likely be met prior to the end of the specified time period.

It should be understood that the various components of the system 400 (e.g., the demand selector 420, demand sorter 410 and calculator 430) could be implemented, as illustrated, by discrete units (e.g., discrete computer systems or discrete computer processing units within the same computer system (i.e., discrete processors)). Alternatively, any two or more of these components could be implemented by a single unit (e.g., by a single computer system or by a single computer processing unit (i.e., a single processor)). Similarly, as described above and illustrated in FIG. 4, the stored information (e.g., the demands 401, sorting rules 402 and leveling rules 403) can be stored by discrete memories. Alternatively, any of this stored information can be stored on the same memory.

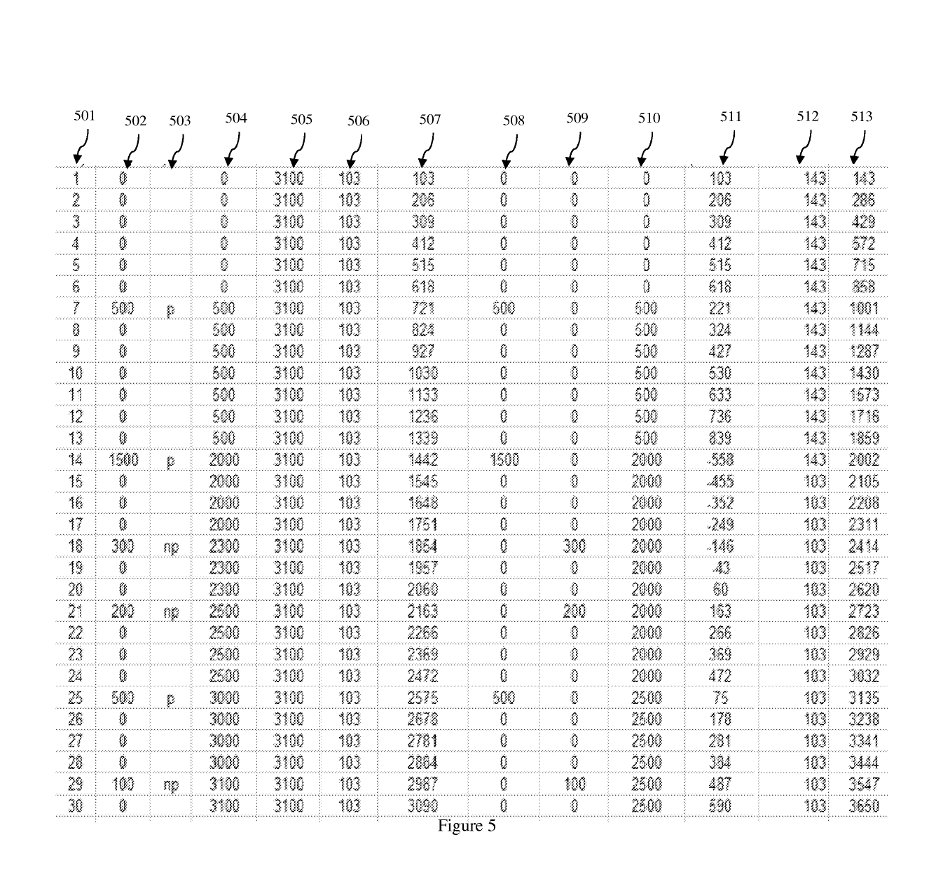

FIG. 5 is an exemplary table further illustrating the various process steps and output of the method of FIGS. 2 and 3, which, as discussed above, can be implemented using the system 400 of FIG. 4. In this exemplary table, the following is shown.

As indicated in column 501, each row in the table refers to a regular time interval and, particularly, a single day, in sequence within a specified time period of thirty days.

Column 502 shows the calculation, for all demands that fall within the specific time period, specific item quantities that fall due on specific days, also referred to as the demand quantity (see process steps 202 and 206 of FIG. 2). For example, on each of days 1-6 the item quantities are 0; on day 7 the item quantity is 500; and so on). Column 503 shows the priority (i.e., high or prioritized (P) and low or non-prioritized (NP) associated with the demands from column 502, also referred to as the demand type (see process step 204 of FIG. 2). Columns 504-505 show the calculation of the total item quantity of 3100 associated with all of the demands within the specified time period (i.e., the sum of the item quantities listed for each day 1-30 in column 502), also referred to as the total period demand (see process step 208 of FIG. 2).

Column 506 shows the calculation of the average item quantity for each day (i.e., the daily average item quantity), which is equal to 103 and determined by dividing the total item quantity of 3100 from column 505 by the total number of days 30 within the specified time period from column 501, also referred to as the simply-leveled demand (see process step 210 of FIG. 2).

Column 507 shows the calculation of the first running cumulative sum of the daily average item quantities associated with all demands within the specified time period from column 506, also referred to as the cumulative of the simply-leveled demand (see process step 212 of FIG. 2). Specifically, in calculating this first running cumulative sum shown in column 507: day 1 is equal to the daily average item quantity (i.e., 103); day 2 is equal to the value from the day 1 (i.e., 103) plus 103 (i.e., 206); day 3 is equal to the value of day 2 (i.e., 203) plus 103 (i.e., 309); and so on.

Column 508 shows only the high priority demands from column 503 by day, also referred to as the prioritized demands. Column 509 shows only the low priority demands from column 503 by day, also referred to as the non-prioritized demands.

Column 510 shows the calculation of a second running cumulative sum of the specific item quantities associated with only the high priority demands from column 508 (i.e., the item quantities of 500, 1500 and 500 from days 7, 14, and 25, respectively), also referred to as the cumulative of prioritized demands (see process step 214). Specifically, in calculating this second running cumulative sum: days 1-6 will be 0; days 7-13 will 500, days 14-24 will be 2000 and days 25-30 will be 2500.

Column 511 shows the comparison of the first and second running cumulative sums and particularly, the calculation, for each day 1-30 in sequence, of the difference between an entry in the running cumulative sum of the daily average quantities associated with all demands, as shown in column 507, and the corresponding entry in the running cumulative sum of specific item quantities associated with the high priority demands only, as shown in column 510, also referred to as the delta between the cumulative of the simply-leveled demands and the cumulative of the prioritized demands (see process step 216 and also process steps 301a-e of FIG. 3). Day 14 of column 511 has the first negative entry (i.e., −558) and, thus, indicates that the item quantity on day 14 (i.e., entry 14) from the first running cumulative sum of column 507 is less than the item quantity on day 14 (i.e., the corresponding entry 14) from the second running cumulative sum of column 510.

Columns 512-513 show demand leveling based on the comparison shown in column 511. Specifically, column 512 shows that the entry of −558 on day 14 of column 511 can be divided by the entry number (i.e., 14), that the result (i.e., the quotient) of 39.86 can be rounded up to 40 and that this 40 can be added to the average item quantities associated with each of the entries 1-14 of column 506. Thus, in column 512, which is also referred to as the re-leveled demand, the item quantities in entries 1-14 are increased to 143 and the item quantities in entries 15-30 remain at 103. Furthermore, column 513 shows re-calculation of the first running cumulative sum using the updated item quantities from column 513, also referred to as the updated first running cumulative sum or the cumulative of the re-leveled demands (see process step 216 and also process step 302 of FIG. 3).

As mentioned above, the comparing and demand leveling processing should be repeated iteratively. For example, corresponding entries in column 514 and column 510 can be compared and, if necessary, demand leveling will again be performed. However, as illustrated, in this case none of the entries in column 514 are less than the corresponding entries in column 510.

It should be noted that, as a result of demand leveling, demands are shifted towards the beginning of the specified time period and, thus, the total item quantity of 3100 association will all demands is actually met on day 25 and production can stop at that time.

Also disclosed herein are embodiments of a non-transitory program storage device. The program storage device can be readable by a computer and can tangibly embody a program of instructions executable by the computer to perform the production planning method, as described in detail above. More specifically, as will be appreciated by one skilled in the art, aspects of the present invention may be embodied as a system, method or program storage device (i.e., a computer program product). Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a non-transitory computer readable storage device or a computer readable signal medium. A non-transitory computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the non-transitory computer readable storage device would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a non-transitory computer readable storage device may be any tangible medium that can contain, or store a program for use by or in connection with an instruction execution system, apparatus, or device.

As mentioned above, the computer readable medium can alternatively comprise a computer readable signal medium that includes a propagated data signal with computer readable program code embodied therein, for example, in baseband or as part of a carrier wave. Such a propagated signal may take any of a variety of forms, including, but not limited to, electro-magnetic, optical, or any suitable combination thereof. This computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the disclosed embodiments may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the disclosed embodiments are described above with reference to flowchart illustrations and/or block diagrams of methods, apparatus (systems) and computer program products. It will be understood that each block of the flowchart illustrations and/or D-2 block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Referring now to FIG. 6, as mentioned above, this Figure is a schematic drawing illustrating an exemplary hardware environment for practicing the disclosed method, system and program storage device embodiments. Specifically, this schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example. However, it should be understood that the hardware environment shown in FIG. 6 is not intended to be limiting and that the embodiments disclosed herein could, alternatively, be implemented on any other type of computer system having the required data storage and processing capability to perform the described production planning processes (e.g., a laptop computer, tablet computer, handheld device, smart phone, etc.).

It should be understood that the flowcharts and block diagrams in the Figures referenced above illustrate the architecture, functionality, and operation of the various possible implementations of the disclosed systems, methods and computer program products. In this regard, each block in the flowchart or block diagrams may represent a module, segment, or portion of code, which comprises one or more executable instructions for implementing the specified logical function(s). It should also be noted that, in some alternative implementations, the functions noted in any block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should further be understood that the terminology used herein is for the purpose of describing particular embodiments only and is not intended to be limiting. As used herein, the singular forms “a”, “an” and “the” are intended to include the plural forms as well, unless the context clearly indicates otherwise. Additionally, as used herein, the terms “comprises” “comprising”, “includes”, and/or “including”, specify the presence of stated features, integers, steps, operations, elements, and/or components, but do not preclude the presence or addition of one or more other features, integers, steps, operations, elements, components, and/or groups thereof. It should further be understood that the corresponding structures, materials, acts, and equivalents of all means or step plus function elements in the claims below are intended to include any structure, material, or act for performing the function in combination with other claimed elements as specifically claimed. Additionally, it should be understood that the detailed description above is presented for purposes of illustration and is not intended to be exhaustive or limiting. More specifically, the detailed description was provided to best explain the principles and practical application of the disclosed embodiments and to enable others of ordinary skill in the art to understand the disclosed embodiments. Many modifications and variations to the embodiments will be apparent to those of ordinary skill in the art without departing from the scope and spirit thereof.

Therefore, disclosed above are embodiments of a production planning method, system and program storage device. The embodiments can calculate and compare, in sequence, a first running cumulative sum of the average item quantity per a regular time interval (e.g., per day) for all demands within a specified time period and a second running cumulative sum of specific item quantities per the same regular interval (e.g., per day) for only high priority demands within the same specified time period. When a given entry in the first running cumulative sum is less than a corresponding entry in the second running cumulative sum, demand leveling can be performed. That is, a leveling item quantity can be added to the average item quantities associated with at least some entries up to and including the given entry. Then, the first running cumulative sum can be re-calculated to generate an updated first running cumulative sum. The comparing and demand leveling processes can be iteratively repeated until none of the entries in the first running cumulative sum, as updated, are less than the corresponding entries in the second running cumulative sum (i.e., until demand leveling is achieved). The results of such demand leveling can then be used for production planning in order to achieve near-capacity manufacturing and meet at least the high priority customer demands. It should further be noted that the above-described embodiments base demand leveling on forward-looking customer inputs (e.g., actual and/or forecasted customer orders) as opposed to historical data. The results allow manufacturers to avoid potentially sacrificing customer satisfaction in order to benefit manufacturing, without requiring continuous updates as demands change. Additionally, the embodiments eliminate the potential of overbuilding by backing demand off at the end of the horizon (i.e., planning for less demand and the end of the horizon) and, as a result, minimize inventory costs. Consequently, the embodiments have the advantage of improving product yield, improving capacity utilization and increasing overall manufacturing output.

What is claimed is:

1. A computer-implemented production planning method in manufacturing, said method comprising:
determining, by a computer system, a total item quantity associated with multiple demands within a specified time period, said multiple demands comprising high priority demands and low priority demands;
based on said total item quantity and for each regular time interval within said specified time period, determining, by said computer system, an average item quantity;
calculating, by said computer system, a first running cumulative sum of average item quantities from a first regular time interval to a last regular time interval within said specified time period;
calculating, by said computer system and for said high priority demands only, a second running cumulative sum of specific item quantities from said first regular time interval to said last regular time interval;
comparing, by said computer system and in sequence beginning with said first regular time interval, entries in said first running cumulative sum to corresponding entries in said second running cumulative sum; and
when a given entry in said first running cumulative sum is less than a corresponding entry in said second running cumulative sum, performing, by said computer system, demand leveling comprising:
adding a demand-leveling item quantity to said average item quantity associated with at least some entries up to and including said given entry; and
re-calculating said first running cumulative sum so as to generate an updated first running cumulative sum.

2. The method of claim 1, further comprising:
sorting, by said computer system, each of said multiple demands into said high priority demands and said low priority demands.

3. The method of claim 1, said performing of said demand leveling further comprising:
determining said difference between said given entry and said corresponding entry;
determining a number of said given entry in said first running cumulative sum;
dividing said difference by said number; and
based on a result of said dividing and on pre-defined demand-leveling rules, determining said demand-leveling item quantity and selecting said at least some entries.

4. The method of claim 1, said regular time interval comprising any one of a work shift, a single day, a given number of days, a week, and a month.

5. The method of claim 1, said specified time period comprising any one of a specified number of days, a week, a month, a quarter and a year.

6. The method of claim 1, further comprising, after said re-calculating, iteratively repeating, by said computer system, said comparing, beginning from said first regular time interval, and said demand leveling, until none of said entries in said first running cumulative sum, as updated, are less than said corresponding entries in said second running cumulative sum.

7. The method of claim 1, said high priority demands comprising actual customer orders and said low priority demands comprising forecasted customer orders.

8. A computer-implemented production planning method in manufacturing, said method comprising:
determining, by a computer system, a total item quantity associated with multiple demands within a specified time period, said multiple demands comprising high priority demands and low priority demands;
based on said total item quantity and for each day within said specified time period, determining, by said computer system, an average item quantity;
calculating, by said computer system, a first running cumulative sum of average item quantities from a first day to a last day within said specified time period;
calculating, by said computer system and for said high priority demands only, a second running cumulative sum of specific item quantities from said first day to said last day;
comparing, by said computer system and in sequence beginning with said first day, entries in said first running cumulative sum to corresponding entries in said second running cumulative sum; and
when a given entry in said first running cumulative sum is less than a corresponding entry in said second running cumulative sum, performing, by said computer system, demand leveling comprising:
adding a demand-leveling item quantity to said average item quantity associated with at least some entries up to and including said given entry; and
re-calculating said first running cumulative sum so as to generate an updated first running cumulative sum.

9. The method of claim 8, further comprising:
sorting, by said computer system, each of said multiple demands into said high priority demands and said low priority demands.

10. The method of claim 8, said performing of said demand leveling further comprising:
determining said difference between said given entry and said corresponding entry;
determining a number of said given entry in said first running cumulative sum;
dividing said difference by said number; and
based on a result of said dividing and on pre-defined demand-leveling rules, determining said demand-leveling item quantity and selecting said at least some entries.

11. The method of claim 8, said specified time period comprising any one of a specified number of days, a week, a month, a quarter and a year.

12. The method of claim 8, further comprising, after said re-calculating, iteratively repeating, by said computer system, said comparing, beginning from said first day, and said demand leveling, until none of said entries in said first running cumulative sum, as updated, are less than said corresponding entries in said second running cumulative sum.

13. The method of claim 8, said high priority demands comprising actual customer orders and said low priority demands comprising forecasted customer orders.

14. A system for production planning in manufacturing, said system comprising:
a memory storing multiple demands, said multiple demands comprising high priority demands and low priority demands; and
at least one processor in communication with said memory and performing the following:
determining a total item quantity associated with said multiple demands within a specified time period;
based on said total item quantity and for each regular time interval within said specified time period, determining an average item quantity;
calculating a first running cumulative sum of average item quantities from a first regular time interval to a last regular time interval within said specified time period;
calculating, for said high priority demands only, a second running cumulative sum of specific item quantities from said first regular time interval to said last regular time interval;
comparing, in sequence beginning with said first regular time interval, entries in said first running cumulative sum to corresponding entries in said second running cumulative sum; and,
when a given entry in said first running cumulative sum is less than a corresponding entry in said second running cumulative sum, said demand leveling comprising:
adding a demand-leveling item quantity to said average item quantity associated with at least some entries up to and including said given entry; and
re-calculating said first running cumulative sum so as to generate an updated first running cumulative sum.

15. The system of claim 14, said at least one processor sorting each of said multiple demands into said high priority demands and said low priority demands.

16. The system of claim 14, said at least on processor further performing the following:
determining said difference between said given entry and said corresponding entry;
determining a number of said entry in said first running cumulative sum;
dividing said difference by said number; and
based on a result of said dividing and on pre-defined demand-leveling rules, determining said demand-leveling item quantity and selecting said at least some entries.

17. The system of claim 14, said regular time interval comprising any one of a work shift, a single day, a given number of days, a week, and a month.

18. The system of claim 14, said specified time period comprising any one of a specified number of days, a week, a month, a quarter and a year.

19. The system of claim 14, said at least one processor further iteratively repeating said comparing, beginning from said first regular time interval, and said demand leveling until none of said entries in said first running cumulative sum, as updated, are less than said corresponding entries in said second running cumulative sum.

20. The system of claim 14, said high priority demands comprising actual customer orders and said low priority demands comprising forecasted customer orders.

21. A non-transitory program storage device readable by a computer and tangibly embodying a program of instructions executable by said computer to perform a production planning method in manufacturing, said method comprising:
determining a total item quantity associated with multiple demands within a specified time period, said multiple demands comprising high priority demands and low priority demands;
based on said total item quantity and for each regular time interval within said specified time period, determining an average item quantity;
calculating a first running cumulative sum of average item quantities from a first regular time interval to a last regular time interval within said specified time period;
calculating, for said high priority demands only, a second running cumulative sum of specific item quantities from said first regular time interval to said last regular time interval;
comparing, in sequence beginning with said first regular time interval, entries in said first running cumulative sum to corresponding entries in said second running cumulative sum; and
when a given entry in said first running cumulative sum is less than a corresponding entry in said second running cumulative sum, performing demand-leveling comprising:
adding a demand-leveling item quantity to said average item quantity associated with at least some entries up to and including said given entry; and
re-calculating said first running cumulative sum so as to generate an updated first running cumulative sum.

22. The program storage device of claim 21, said method further comprising sorting each of said multiple demands into said high priority demands and said low priority demands.

23. The program storage device of claim 21, said performing of said demand leveling further comprising:
determining said difference between said given entry and said corresponding entry;
determining a number of said entry in said first running cumulative sum;
dividing said difference by said number; and
based on a result of said dividing and on pre-defined demand-leveling rules, determining said demand-leveling item quantity and selecting said at least some entries.

24. The program storage device of claim 21, said regular time interval comprising any one of a work shift, a single day, a given number of days, a week, and a month.

25. The program storage device of claim 21, said specified time period comprising any one of a specified number of days, a week, a month, a quarter and a year.
